(19) United States
(12) Patent Application Publication
(10) Pub. No.: US 2025/0298277 A1
(43) Pub. Date: Sep. 25, 2025

(54) OPTICAL DEVICE PROVIDED WITH A LIQUID CRYSTAL SCREEN

(71) Applicant: VALEO VISION, Bobigny (FR)

(72) Inventor: Berkan ABACI, Bobigny (FR)

(73) Assignee: VALEO VISION, Bobigny (FR)

(21) Appl. No.: 18/864,179

(22) PCT Filed: May 5, 2023
(86) PCT No.: PCT/EP2023/061928

§ 371 Date: Nov. 8, 2024

(30) Foreign Application Priority Data
May 10, 2022 (FR) 2204428

(51) Int. Cl. G02F 1/1343; F21S 41/64; G02F 1/1333; G02F 1/1334

(52) U.S. Cl. CPC G02F 1/13439; F21S 41/645; G02F 1/133382; G02F 1/1334

(57) ABSTRACT

An optical device for an automotive vehicle, including a layer of liquid crystals, a first layer of an electrically conductive coating, and a second layer of an electrically conductive coating. The first layer and the second layer being two separate layers arranged on either side of the layer of liquid crystals. The first layer including a first positive terminal and the second layer including a first negative terminal. The first positive terminal and the first negative terminal being intended to be connected to a first electric power source so as to generate an electric field through the layer of liquid crystals, at least one layer of the first layer and the second layer includes a second positive terminal and a second negative terminal.

### TECHNICAL FIELD

The invention relates to an optical device for an automotive vehicle, the optical device comprising a liquid crystal screen, notably a polymer-dispersed liquid crystal (PDLC) screen. The invention also relates to a luminous device for an automotive vehicle comprising such an optical device. The invention also relates to a method for using such an optical device.

### BACKGROUND OF THE INVENTION

Liquid crystal screens are optical devices in which the transparency varies according to an electric field passing therethrough. Liquid crystal screens are used to perform a wide variety of optical functions and are therefore of interest to operators in the automotive industry. For example, automotive vehicles equipped with a panoramic roof provided with a polymer-dispersed liquid crystal (PDLC) screen are known. The level of transparency of the panoramic roof can be easily controlled, allowing the ambience within the passenger compartment to be changed.

However, the liquid crystal screens known in the prior art do not work at low temperature. This constraint limits the use of liquid crystal screens in the automotive industry since automotive vehicles must retain full functionality at low temperature, in particular at negative temperatures, or even at −20° C., or even at −40° C.

Furthermore, liquid crystal screens for automotive vehicles must remain simple, compact and easy to manufacture.

### SUMMARY OF THE INVENTION

The purpose of the invention is to provide an optical device provided with a liquid crystal screen for an automotive vehicle that overcomes the aforementioned drawbacks and improves the optical devices known from the prior art.

More precisely, a first subject of the invention is a simple, compact optical device that is easy to manufacture and capable of operating at low temperature.

The invention relates to an optical device for an automotive vehicle, comprising a layer comprising liquid crystals, a first layer of an electrically conductive coating, and a second layer of an electrically conductive coating, said first layer and said second layer being two separate layers arranged on either side of the layer comprising liquid crystals, said first layer comprising a first positive terminal and said second layer comprising a first negative terminal, the first positive terminal and the first negative terminal being intended to be connected to a first electric power source so as to generate an electric field through the layer comprising liquid crystals, at least one layer of said first layer and said second layer comprising a second positive terminal and a second negative terminal intended to be connected to a second electric power source so as to cause an electric current to flow through this layer, between the second positive terminal and the second negative terminal.

The first positive terminal and the second positive terminal may form a single positive terminal, or the first negative terminal and the second negative terminal may form a single negative terminal

The first positive terminal, the second positive terminal, the first negative terminal and the second negative terminal may be four separate terminals.

The layer comprising liquid crystals may be a layer comprising liquid crystals dispersed in a polymer, and/or said first layer and/or said second layer may be a layer of indium tin oxide.

The optical device may comprise a first electric power source electrically connected to the first positive terminal and to the first negative terminal, and a second electric power source electrically connected to the second positive terminal and to the second negative terminal.

The first power source may be an AC power source.

The second power source may be a DC power source or alternatively an AC power source.

The second positive terminal and the second negative terminal may be spaced apart from each other by a distance greater than or equal to 50% of a largest dimension of the layer of electrically conductive coating comprising them.

The layer comprising the second positive terminal and the second negative terminal may comprise a rectangular shape, the second positive terminal and/or the second negative terminal extending along at least 50% of a short side of the rectangular shape.

The invention also relates to a luminous device for an automotive vehicle, the luminous device comprising a light source and an optical device as defined above, the optical device being arranged so as to receive light rays coming from the light source.

The invention also relates to a method for controlling an optical device as defined above or a luminous device as defined above, the control method comprising:
detecting a temperature less than or equal to a threshold, then
causing an electric current to flow between the second positive terminal and the second negative terminal to heat the layer of electrically conductive coating comprising the second positive terminal and the second negative terminal.

### BRIEF DESCRIPTION OF DRAWINGS

These subjects, features and advantages of the present invention will be set forth in detail in the following description of a particular embodiment given by way of non-limiting example in conjunction with the accompanying figures, in which:

FIG. 1 is a schematic view in cross section of a luminous device according to one embodiment of the invention.

FIG. 2 is a schematic view in cross section of an optical device of the luminous device in FIG. 1.

FIG. 3 is a schematic top view of the optical device in FIG. 2.

FIG. 4 is a schematic view in cross section of an optical device according to a variant embodiment of the invention.

FIG. 5 is a schematic top view of the optical device in FIG. 4.

### DETAILED DESCRIPTION

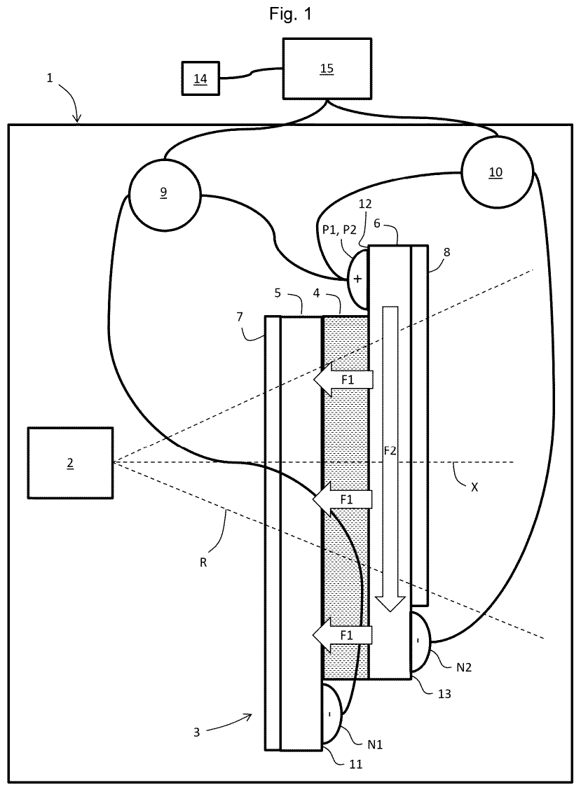

FIG. 1 schematically illustrates a luminous device 1 for an automotive vehicle according to one embodiment of the invention. The luminous device 1 can be positioned anywhere on the vehicle, for example at the front or at the rear of the vehicle. The luminous device 1 can participate in the luminous signature of the vehicle. The luminous device 1 comprises a light source 2 and an optical device 3 according to one embodiment of the invention. The light source 2 may for example comprise one or more light-emitting diodes and/or one or more incandescent bulbs. The optical device 3 is arranged so as to receive light rays R coming from the light source 2. These light rays R can form a light beam centered on an optical axis X. The light rays R can be emitted in any zone of the visible spectrum.

The optical device 3 comprises a layer comprising liquid crystals 4, a first layer 5 of an electrically conductive coating, and a second layer 6 of an electrically conductive coating. The layer comprising liquid crystals 4, hereinafter referred to as the layer of liquid crystals 4, is a screen extending generally in a plane. This plane may be substantially perpendicular to the optical axis X. The first layer 5 and the second layer 6 are two separate layers arranged on either side of the layer of liquid crystals 4. The first layer 5 and the second layer 6 therefore extend respectively over two opposite faces of the layer of liquid crystals 4. In particular, the two opposite faces of the layer of liquid crystals 4 are completely covered by the first layer 5 and by the second layer 6 respectively. The first layer 5 may face the light source 2 and the second layer 6 may be arranged on the side opposite the light source 2. In a variant, the positioning of the first layer and of the second layer could be inverted.

The layer of liquid crystals 4 is capable of modifying the trajectory of light rays passing through it according to an electric field applied thereto. In particular, the layer of liquid crystals 4 is capable of modifying its transparency level according to an electric field applied thereto. The layer of liquid crystals 4 may comprise a crystalline liquid in which the elongated molecules assume an ordered orientation when the layer of liquid crystals is subjected to a given electric field. The ordered orientation of the molecules makes the crystalline liquid transparent. Conversely, when the layer of liquid crystals is not subjected to an electric field, the molecules can be oriented according to a nematic, cholesteric or smectic configuration, which makes the crystalline liquid opaque or translucent. These properties of the layer of liquid crystals 4 can be obtained only from a given temperature, for example when the layer of liquid crystals 4 is at a temperature greater than or equal to 0° C. According to a preferred embodiment, the layer of liquid crystals 4 is a layer of liquid crystals, optionally in the form of birefringent droplets, dispersed in a polymer matrix, commonly known as polymer-dispersed liquid crystal (PDLC). The thickness of the layer of liquid crystals 4 may typically be between 15 μm and 30 μm.

The first layer 5 and the second layer 6 are configured to apply an electric field to the layer of liquid crystals 4. The first layer 5 and the second layer 6 are capable of conducting electricity but nevertheless possess an intrinsic electric resistance. The first layer 5 and the second layer 6 may be generally transparent. These layers may optionally comprise a slight coloration. Notably, the first layer 5 and the second layer 6 may be layers of indium tin oxide ITO, commonly referred to as ITO. The thickness of the first layer 5 and/or of the second layer 6 may typically be between 30 nm and 50 nm.

The first layer 5 and the second layer 6 may be covered on the free face thereof respectively with a layer 7, 8 of transparent and electrically insulating material, notably a layer of thermoplastic saturated polyester, in particular a layer of polyethylene terephthalate, commonly referred to as PET. These layers may be obtained by a thermally induced phase separation process or a polymerization-induced phase separation (PIPS) process. The layers 7, 8 of thermoplastic saturated polyester may form a protective envelope enveloping both the layer of liquid crystals 4, the first layer 5 and the second layer 6. The layers 7 and 8 may also constitute a support on which the first layer 5 and the second layer 6 are deposited respectively. Incidentally, the various layers shown in FIGS. 1, 2 and 4 are shown schematically and their apparent thickness may be disproportionate.

The second layer 6 comprises a first positive terminal P1 and the first layer 5 comprises a first negative terminal N1. The first positive terminal P1 and the first negative terminal N1 are connected to a first electric power source 9, so as to generate an electric field passing through the layer of liquid crystals 4, notably to orient the molecules which make up the layer of liquid crystals. The electric field thus obtained can be oriented substantially parallel to the optical axis X. This electric field is represented by arrows F1 in FIGS. 1, 2 and 4. Preferably, the first power source 9 may be an AC power source. The potential difference between the first positive terminal P1 and the first negative terminal N1 may be between 70 V and 120 V peak-to-peak, when an electric field is established.

Furthermore, as illustrated in FIG. 1, the second layer 6 comprises a second positive terminal P2 and a second negative terminal N2. In this case, the first positive terminal P1 and the second positive terminal P2 form a single positive terminal. The second positive terminal P2 and the second negative terminal N2 are connected to a second electric power source 10, configured so as to cause an electric current to flow through this second layer 6, between the second positive terminal P2 and the second negative terminal N2. This electric current is represented by an arrow F2 in FIGS. 1, 2 and 4. Preferably, the second power source 10 may be a DC power source. The potential difference between the second positive terminal P2 and the second negative terminal N2 can be determined as a function of the dimensions of the layer of liquid crystals. It may for example reach about ten volts, or even more, when an electric current is flowing between the second positive terminal P2 and the second negative terminal N2.

The positive terminals P1 and P2 and the negative terminals N1 and N2 are therefore three separate electric terminals electrically connected to the first layer 5 or to the second layer 6. These electric terminals may for example be obtained by welding an electric wire or by using an adhesive.

The dimensions along at least one axis perpendicular to the optical axis X of the first layer 5 and/or of the second layer 6 may be strictly greater than a dimension of the layer of liquid crystals 4 along this same axis. This provides portions 11, 12 of the first layer 5 and of the second layer 6 respectively which are offset with respect to the layer of liquid crystals 4. These portions 11, 12 provide contact surfaces on which the electric terminals P1, P2, N1, N2 can be arranged. In a variant or additionally, the layer 7 and/or 8 of transparent and electrically insulating material may be locally perforated so as to expose a portion 13 of the first layer 5 and/or of the second layer 6 on which an electric terminal is arranged.

By a surprising effect, the electric current generated by the second power source 10 heats the second layer 6. By thermal conduction, the layer of liquid crystals 4 can thus be brought to a temperature sufficient to guarantee its proper operation. The second layer 6 thus forms a means for heating the layer of liquid crystals 4. Advantageously, this heating means is formed by a layer of an electrically conductive coating that is already required to generate an electric field through the thickness of the layer of liquid crystals 4. It is therefore sufficient simply to provide at least one additional electric terminal and a second electric power source to form this heating means.

The first power source 9 and the second power source 10, as well as a temperature sensor 14, are electrically connected to an electronic control unit 15. Incidentally, the first power source 9, the second power source 10 and the electronic control unit 15 may optionally be built into a single housing. The electronic control unit 15 is configured to control the second power source 10 as a function of a temperature detected by the temperature sensor 14. A method of controlling the optical device 3 can be implemented as follows: firstly, the temperature sensor 14 is used to detect a temperature less than or equal to a threshold, for example a threshold of 0° C., −10° C. or even −20° C. Then, the electronic control unit 15 commands the second power source 10 to deliver an electric current. This electric current flows between the second positive terminal P2 and the second negative terminal N2 to heat the second layer 6.

Advantageously, the second positive terminal P2 and the second negative terminal N2 are positioned substantially at two opposite ends of the second layer 6. They may be spaced apart from each other by a distance greater than or equal to at least 50% of the largest dimension of the second layer, or at least 75% of the largest dimension of the second layer. Thus, the generated heat is well distributed over the entire length of the second layer 6.

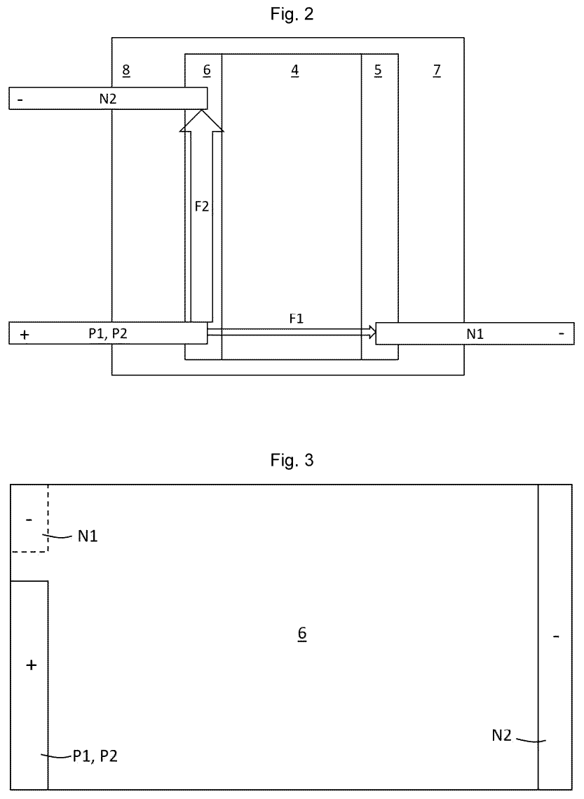

As shown in FIGS. 2 and 3 illustrating the first embodiment of the optical device 3, the second layer 6 comprises the first positive terminal P1, the second positive terminal P2 and the second negative terminal N2. The first positive terminal P1 and the second positive terminal P2 form a single positive terminal. The first layer 5 comprises only the first negative terminal N1. The first layer and the second layer 6 may comprise a generally rectangular shape. Advantageously, the second positive terminal P2 and the second negative terminal N2 extend respectively along the two opposite short sides of the rectangular shape. This maximizes the distance between the terminals P2 and N2 and optimizes the heating obtained. Preferably, the second positive terminal and/or the second negative terminal extend respectively along at least 50% of the short side of the rectangular shape, preferably at least 75% of the short side of the rectangular shape, or even the whole of the short side of the rectangular shape. Increasing the surface area of the second positive terminal P2 and/or of the second negative terminal N2 improves the distribution of the electron flux in the second layer 6, resulting in more powerful heating.

According to a variant embodiment (not shown), the positive terminals would be transformed into negative terminals and the negative terminals would be transformed into positive terminals. This provides an optical device in which the first negative terminal and the second negative terminal form one and the same electric terminal. According to another variant embodiment, the second positive terminal and the second negative terminal could be arranged on the first layer 5.

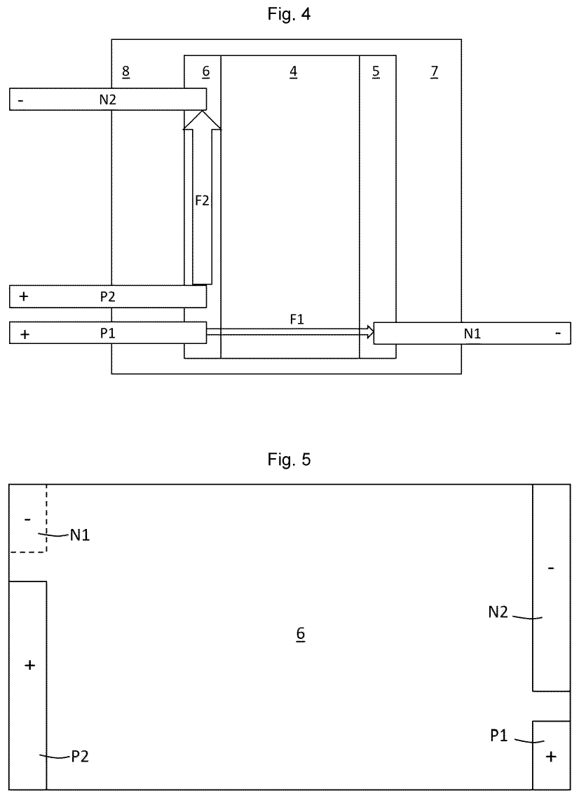

FIGS. 4 and 5 show another variant embodiment of the optical device 3. For the description of this embodiment, the references used in the description of the first embodiment are also used to designate the same objects. Moreover, only the differences with respect to the first embodiment are described. This second embodiment differs from the described first embodiment mainly in that the first positive terminal P1 is separate from the second positive terminal P2. The optical device thus comprises four separate electric terminals P1, P2, N1 and N2. One advantage of this second embodiment could be to enable an electric field to be established between the first positive terminal P1 and the first negative terminal N1 simultaneously with the flow of an electric current between the second positive terminal P2 and the second negative terminal N2. This would enable the layer of liquid crystals to be heated while generating an electric field intended to make the layer of liquid crystals transparent. On the other hand, this embodiment requires the use of an additional electric terminal with respect to the first embodiment. Advantageously, the first positive terminal P1 is not positioned between the second positive terminal P2 and the second negative terminal N2. Thus, the flow of an electric current between the second positive terminal P2 and the second negative terminal N2 does not disturb the electric field between the first layer 5 and the second layer 6. As before, and according to another variant embodiment (not shown), the positive terminals and the negative terminals could be inverted.

According to yet another variant (not shown), the first layer could comprise a first positive terminal and a first negative terminal, and the second layer could comprise a second positive terminal and a second negative terminal. The first layer could form a first heating means by causing an electric current to flow between the first positive terminal and the first negative terminal. The second layer could form a second heating means by causing an electric current to flow between the second positive terminal and the second negative terminal. The electric field passing through the thickness of the layer of liquid crystals 4 could be obtained by means of a power source connected on the one hand to the first positive terminal and/or to the first negative terminal, and connected on the other hand to the second positive terminal and/or to the second negative terminal.

Finally, each of the presented embodiments provides an optical device 3 capable of operating at low temperature, in particular at temperatures less than or equal to −20° C. The heating means built into the optical device is partly based on existing components. The optical device 3 thus remains simple, compact and easy to manufacture. When built into a luminous device, the optical device enables the light signature of a vehicle to be varied according to different circumstances, notably according to an external light level. The optical device 3 described above can also be built into an automotive vehicle independently of any light source. The optical device 3 can for example be used to make a glazed surface of the vehicle opaque or transparent.

What is claimed is:

1. An optical device for an automotive vehicle, comprising a layer including liquid crystals, a first layer of an electrically conductive coating, and a second layer of an electrically conductive coating, the first layer and the second layer being two separate layers arranged on either side of the layer including liquid crystals, the first layer including a first positive terminal and the second layer including a first negative terminal, the first positive terminal and the first negative terminal being intended to be connected to a first electric power source so as to generate an electric field through the layer including liquid crystals, wherein at least one layer of the first layer and the second layer includes a second positive terminal and a second negative terminal intended to be connected to a second electric power source so as to cause an electric current to flow through this layer, between the second positive terminal and the second negative terminal.

2. The optical device as claimed in the claim 1, wherein the first positive terminal and the second positive terminal form a single positive terminal.

3. The optical device as claimed in claim 1, wherein the first positive terminal, the second positive terminal, the first negative terminal and the second negative terminal are four separate terminals.

4. The optical device as claimed in claim 1, wherein the layer including liquid crystals is a layer including liquid crystals dispersed in a polymer.

5. The optical device as claimed in claim 1, further comprising a first electric power source electrically connected to the first positive terminal and to the first negative terminal, and a second electric power source electrically connected to the second positive terminal and to the second negative terminal.

6. The optical device as claimed in claim 5, wherein the first power source is an AC power source, or in that the second power source is a DC power source.

7. The optical device as claimed in claim 1, wherein the second positive terminal and the second negative terminal are spaced apart from each other by a distance greater than or equal to 50% of a largest dimension of the layer of electrically conductive coating including them.

8. The optical device as claimed in claim 1, wherein the layer including the second positive terminal and the second negative terminal includes a rectangular shape, the second positive terminal and/or the second negative terminal extending along at least 50% of a short side of the rectangular shape.

9. A luminous device for an automotive vehicle, comprising a light source and an optical device, the optical device being arranged so as to receive light rays coming from the light source, with the optical device including a layer including liquid crystals, a first layer of an electrically conductive coating, and a second layer of an electrically conductive coating, the first layer and the second layer being two separate layers arranged on either side of the layer including liquid crystals, the first layer including a first positive terminal and the second layer including a first negative terminal, the first positive terminal and the first negative terminal being intended to be connected to a first electric power source so as to generate an electric field through the layer including liquid crystals, wherein at least one layer of the first layer and the second layer includes a second positive terminal and a second negative terminal intended to be connected to a second electric power source so as to cause an electric current to flow through this layer, between the second positive terminal and the second negative terminal.

10. A method for controlling an optical device, with the optical device including a layer including liquid crystals, a first layer of an electrically conductive coating, and a second layer of an electrically conductive coating, the first layer and the second layer being two separate layers arranged on either side of the layer including liquid crystals, the first layer including a first positive terminal and the second layer including a first negative terminal, the first positive terminal and the first negative terminal being intended to be connected to a first electric power source so as to generate an electric field through the layer including liquid crystals, wherein at least one layer of the first layer and the second layer includes a second positive terminal and a second negative terminal intended to be connected to a second electric power source so as to cause an electric current to flow through this layer, between the second positive terminal and the second negative terminal the method comprising:
detecting a temperature less than or equal to a threshold, and
causing an electric current to flow between the second positive terminal and the second negative terminal to heat the layer of electrically conductive coating including the second positive terminal and the second negative terminal.

11. The optical device as claimed in the claim 1, wherein the first negative terminal and the second negative terminal form a single negative terminal.

12. The optical device as claimed in claim 1, wherein the first layer or the second layer is a layer of indium tin oxide.

13. The optical device as claimed in claim 1, wherein the first layer and the second layer is a layer of indium tin oxide.

14. The optical device as claimed in claim 5, wherein the first power source is an AC power source and the second power source is a DC power source.
